(19) United States
(12) Patent Application Publication
(10) Pub. No.: US 2023/0273826 A1
(43) Pub. Date: Aug. 31, 2023

(54) NEURAL NETWORK SCHEDULING METHOD AND APPARATUS, COMPUTER DEVICE, AND READABLE STORAGE MEDIUM

(71) Applicant: SHENZHEN CORERAIN TECHNOLOGIES CO., LTD., Shenzhen (CN)

(72) Inventors: Jiongkai Huang, Shenzhen (CN); Kuenhung TSOI, Shenzhen (CN); Xinyu NIU, Shenzhen (CN)

(73) Assignee: SHENZHEN CORERAIN TECHNOLOGIES CO., LTD., Shenzhen (CN)

(21) Appl. No.: 17/768,241

(22) PCT Filed: Oct. 12, 2019
(86) PCT No.: PCT/CN2019/110823

§ 371 Date: Apr. 12, 2022

(51) Int. Cl. G06F 9/50; G06N 3/08

(52) U.S. Cl. CPC G06F 9/5027; G06N 3/08

(57) ABSTRACT

A neural network scheduling method provided includes loading at least one pre-trained neural network model to a model storage area in a memory, and acquiring a base address of the at least one neural network model, the memory further including a common data storage area; acquiring base addresses of corresponding neural network models according to a task type, and reading data in the common data storage area; and invoking, on a basis of the base addresses of the corresponding neural network models, the corresponding neural network models to compute the data read in the common data storage area to obtain a computation result and outputting the computation result. The cost for additional neural network computing devices can be reduced and the utilization rate of hardware resources can be improved.

### FIELD

The present disclosure relates to the technical field of artificial intelligence, and in particular, to a neural network scheduling method, a neural network scheduling apparatus, a computer device, and a readable storage medium.

### BACKGROUND

In some specific application scenes of artificial intelligence (unmanned driving, face recognition, etc.), it is necessary to run multiple neural network models to obtain the desired results. For example, in a face recognition application scene, it is required to invoke a neural network model to detect whether an image contains a face image of a person first; and if it is detected that a face image of a person is presented, to invoke another neural model to recognize the face image of the person in this image, and finally the desired result is obtained. However, in the current solution in the conventional technology, multiple hardware devices are used, and each of the hardware devices runs a different neural network model, which increases additional device costs and reduces the utilization rate of hardware resources.

### SUMMARY

Embodiments of the present disclosure provides a neural network scheduling method, a neural network scheduling apparatus, a computer device, and a readable storage medium, in order to reduce additional device costs and improve utilization rate of hardware resources.

In order to address the above technical problems, a neural network scheduling method is provided according to embodiments of the present disclosure, which includes technical solutions as follows.

The neural network scheduling method includes:
loading at least one pre-trained neural network model to a model storage area in a memory, and acquiring a base address of the at least one neural network model, where the memory further includes a common data storage area;
acquiring base addresses of corresponding neural network models according to a task type, and reading data in the common data storage area; and
invoking, on the basis of the base addresses of the corresponding neural network models, the corresponding neural network models to compute the data read in the common data storage area to obtain a computation result, and outputting the computation result.

Further, the model storage area is configured to store a network structure of the at least one neural network model of the at least one neural network model and parameters of the at least one neural network model.

Further, the base address is an initial storage address of a neural network model in the memory.

Further, the invoking, on the basis of the base addresses of the corresponding neural network models, the corresponding neural network models to compute the data read in the common data storage area specifically includes:
preprocessing the data; and
inputting the preprocessed data into the invoked neural network for computation.

Further, the inputting the preprocessed data into the invoked neural network for computation specifically includes:
configuring corresponding hardware resources according to network structures of the corresponding neural network models; and
computing the preprocessed data based on the corresponding hardware resources.

Further, training performed to the at least one pre-trained neural network model includes constructing a neural network, selecting a training data set and training the constructed neural network using the selected training data set, and verifying the trained neural network.

In order to address the above technical problems, a neural network scheduling apparatus is further provided according to embodiments of the present disclosure, which includes technical solutions as follows.

The neural network scheduling apparatus includes a loading module, an acquiring module and a computing module.

The loading module is configured to load at least one pre-trained neural network model to a model storage area in a memory, and to acquire a base address of the at least one neural network model, where the memory further comprises a common data storage area;

The acquiring module, configured to acquire base addresses of corresponding neural network models according to a task type, and read data in the common data storage area; and

The computing module, configured to invoke, on the basis of the base addresses of the corresponding neural network models, the corresponding neural network models to compute the data read in the common data storage area to obtain a computation result and to output the computation result.

Further, the computing module includes: a preprocessing sub-module; and a computing sub-module.

The preprocessing sub-module is configured to preprocess the data.

The computing sub-module is configured to input the preprocessed data into the invoked neural network for computation.

In order to address the above technical problems, a computer device is further provided according to embodiments of the present disclosure, which includes technical solutions as follows.

The computer device includes a memory and a processor, where a computer program is stored in the memory, and the processor, when executing the computer program, implements the neural network scheduling method according to any embodiment of the present disclosure.

In order to address the above technical problems, a computer-readable storage medium is further provided according to embodiments of the present disclosure, which includes technical solutions as follows.

The computer-readable storage medium, stores a computer program, where the computer program, when being executed by a processor, implements the neural network scheduling method according to any embodiment of the present disclosure.

Compared with the related art, the embodiments of the present disclosure mainly have the following beneficial effects: by loading at least one pre-trained neural network model to a model storage area in a memory, and acquiring a base address of the at least one neural network model, the memory further including a common data storage area; acquiring base addresses of corresponding neural network models according to a task type, and reading data in the common data storage area; and invoking, on the basis of the base addresses of the corresponding neural network models, the corresponding neural network models to compute the data read in the common data storage area to obtain a computation result and outputting the computation result, trained neural networks can be loaded into the memory in advance and a base address of each of the trained neural networks can be acquired, then the multiple neural networks corresponding to the above base addresses can be sequentially invoked according to the task type to compute the data read in the common data storage area, and an intermediate result can be stored in the common data storage area, i.e., computations of the above-mentioned multiple neural networks can be executed on a same computing device. In this way, the cost for additional neural network computing devices can be reduced and the utilization rate of hardware resources can be improved.

### BRIEF DESCRIPTION OF DRAWINGS

In order to illustrate the solutions in the present disclosure more clearly, the drawings used in the description of the embodiments of the present disclosure are briefly introduced hereinafter. Apparently, the drawings described herein are some embodiments of the present disclosure, and for those of ordinary skill in the art, other drawings can also be obtained from these drawings without any creative effort.

FIG. 1 shows a schematic flowchart of a neural network scheduling method according to an embodiment of the present disclosure;

FIG. 2 shows a schematic flowchart of step 103 in FIG. 1 according to an embodiment;

FIG. 3 shows a schematic flowchart of the step 1032 in FIG. 2 according to an embodiment;

FIG. 4 is a schematic structural diagram of a neural network scheduling apparatus according to an embodiment of the present disclosure;

FIG. 5 is a schematic structural diagram of the computing module 203 in FIG. 4 according to an embodiment; and

FIG. 6 is a schematic structural diagram of a computer device according to an embodiment of the present disclosure.

### DETAILED DESCRIPTION

Unless otherwise defined, all technical and scientific terms used herein have the same meaning as commonly understood by those of ordinary skill in the technical field of this application. The terms used in the specification of the application herein are intend to describe embodiments only rather than to limit the present disclosure. The terms “comprise/include” and “have” and any variations thereof in the description and claims and the above description of drawings of this application are intended to cover non-exclusive inclusion. The terms “first”, “second” and the like in the description and claims or the above description of drawings of the present disclosure are used to distinguish different objects, rather than describing a specific order.

Reference herein to an “embodiment” means that a particular feature, structure, or characteristic described in connection with the embodiment can be included in at least one embodiment of the present disclosure. The appearances of this word “embodiment” in various positions in the specification are not all necessarily referring to a same embodiment, nor referring to a separate or alternative embodiment that is mutually exclusive of other embodiments. It is explicitly and implicitly understood by the person skilled in the art that the embodiment described may be combined with other embodiments herein.

In order to make those skilled in the art better understand the solutions of the present disclosure, the technical solutions in the embodiments of the present disclosure are described clearly and completely hereinafter with reference to the accompany drawings.

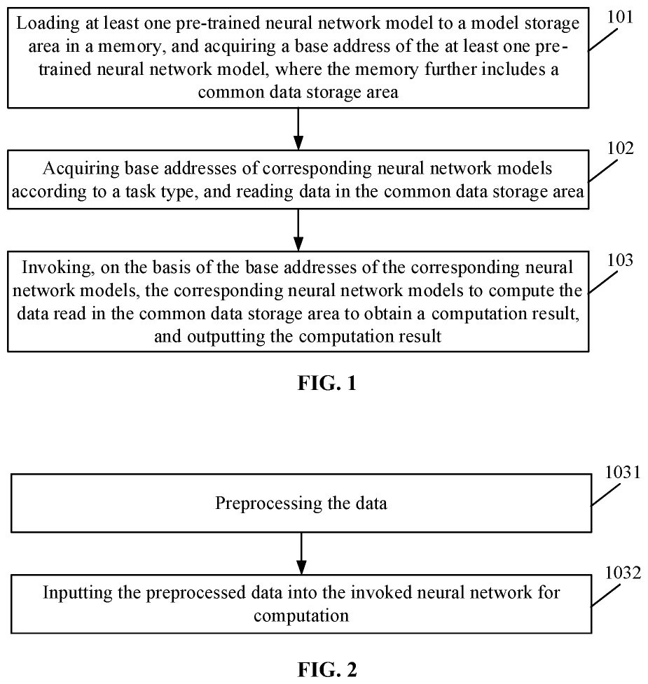

In a first aspect, as shown in FIG. 1, FIG. 1 shows a schematic flowchart of a neural network scheduling method according to an embodiment of the present disclosure. The neural network scheduling method includes the following operations: 101, 102 and 103.

101: Loading at least one pre-trained neural network model to a model storage area in a memory, and acquiring a base address of the at least one neural network model, where the memory further includes a common data storage area.

In this embodiment, the above-mentioned neural network model includes neural networks involved in different task types, such as a feature detection network (CNN, etc.) and a recognition network which are used for a human face recognition task, a recurrent neural network (RNN), a long short-term memory networks (LSTM) and the like which are used for a speech recognition task. First, a storage space with a corresponding size is applied for each of the above-mentioned neural networks in the memory, then a network structure and parameters of each of the above-mentioned neural network models are stored into a corresponding storage space applied above, and a base address (that is, initial address) of each of the neural network models is obtained. Based on the base address, a corresponding neural network can be found as required. Further, a common data storage area may be applied for the above-mentioned neural networks, for storing initially input data and intermediate computation results, etc., which can speed up the computation of the neural networks and save computation resources.

102: Acquiring base addresses of corresponding neural network models according to a task type, and reading data in the common data storage area.

In this embodiment, the task type not only includes the above-mentioned human face recognition and speech recognition, but also includes application scenes in which neural networks are used in tasks such as text recognition, object segmentation, and unmanned driving, and neither types of neural networks nor numbers of neural networks used for various application scenes are the same.

Therefore, it is necessary to select corresponding neural networks for combination according to the task type to perform the corresponding task and realize corresponding functions. Specifically, base addresses, in the memory, of neural networks required by a task are acquired, the corresponding neural networks stored at the above base addresses are loaded into a processor, and the data in the above common data storage area is read and input into the above neural networks loaded into the processor to operate. The above task may require multiple neural networks, and the multiple neural networks can be dynamically switched through corresponding base addresses of the multiple neural networks, to allow the multiple neural networks to be executed sequentially according to invoking.

103: Invoking, on the basis of the base addresses of the corresponding neural network models, the corresponding neural network models to compute the data read in the common data storage area to obtain a computation result and outputting the computation result.

In this embodiment, through the above operation 103, at least one neural network required by the task can be obtained according to the above base address, and then the above obtained neural networks can be sequentially loaded into a same processor to perform corresponding computations based on the data read from the above common data storage area, that is, the neural networks are invoked in turn to compute the data read in the common data storage area, and an intermediate computation result is stored into the above common data storage area for another neural network to use. That is, during the computation, the neural networks can be switched in accordance with the above-described base addresses, and can circularly use the above-described common data storage area until that the last neural network ends computation and that a final result is output, which can improve the utilization rate of the hardware computation resources.

In the embodiments of the present disclosure, the neural network scheduling method is provided, which includes: loading at least one pre-trained neural network model to a model storage area in a memory, and acquiring a base address of the at least one neural network model, the memory further including a common data storage area; acquiring base addresses of corresponding neural network models according to a task type, and reading data in the common data storage area; and, invoking, on the basis of the base addresses of the corresponding neural network models, the corresponding neural network models to compute the data read in the common data storage area to obtain a computation result and outputting the computation result. According to the method, trained neural networks can be loaded into the memory in advance and a base address of each of the trained neural networks can be acquired, then the multiple neural networks corresponding to the above base addresses can be sequentially invoked according to the task type to compute the data read in the common data storage area, and an intermediate result can be stored in the common data storage area, i.e., computations of the above-mentioned multiple neural networks can be executed on a same computing device. In this way, the cost for additional neural network computing devices can be reduced and the utilization rate of hardware resources can be improved.

Further, the model storage area is configured to store a network structure of the at least one neural network model and parameters of the at least one neural network model.

In this embodiment, the above-mentioned neural network model is a pre-trained neural network, that is, the network structure of the pre-trained neural network is optimal and the parameters of the pre-trained neural network make the pre-trained neural network to have a minimum error. The network structure of the neural network takes layers as computation units, the layers include but are not limited to a convolutional layer, a pooling layer, a ReLU (an activation function), a fully connected layer, and etc. In addition to receiving data flow output by a previous layer, each of the layers in the neural network structure also includes a large number of parameters, and these parameters include but are not limited to: a weight, a bias and the like.

Further, the base address is an initial storage address of a neural network model in the memory.

In this embodiment, segments of memory space may be applied from an operation system to store the above-mentioned neural network models. The segments of the memory space may be continuous for storing the multiple neural networks, or may be discontinuous with only one neural network being stored in each segment of the memory space. It can be obtained from the operation system the base address of each neural network, i.e., the initial address of the neural network in the memory. Through this base address, a corresponding neural network can be found, and the neural network can be loaded and switched to.

Further, as shown in FIG. 2, the above step 103 specifically includes the following operations: 1031 and 1032.

1031: preprocessing the data.

1032: Inputting the preprocessed data into the invoked neural network for computation.

The preprocessing the data includes the following data preprocessing methods:
cleaning the data, which can be used to clean up noise in the data and to correct inconsistencies;
merging the data, which can be used to merge multiple data sources into a consistent data (such as a data warehouse) for storing;
performing reduction to the data, which is used to reduce a scale of the data by, for example, aggregating, deleting redundant features, or clustering; and
performing transformation to the data, which includes normalization, regularization and the like and is used to, for example, compress the data into a smaller range, such as from 0.0 to 1.0.

Through the above data preprocessing methods, the data can be processed into formats required by the neural networks for computation, and input into the above invoked neural networks for corresponding computation, which can improve the computation efficiency of the neural networks.

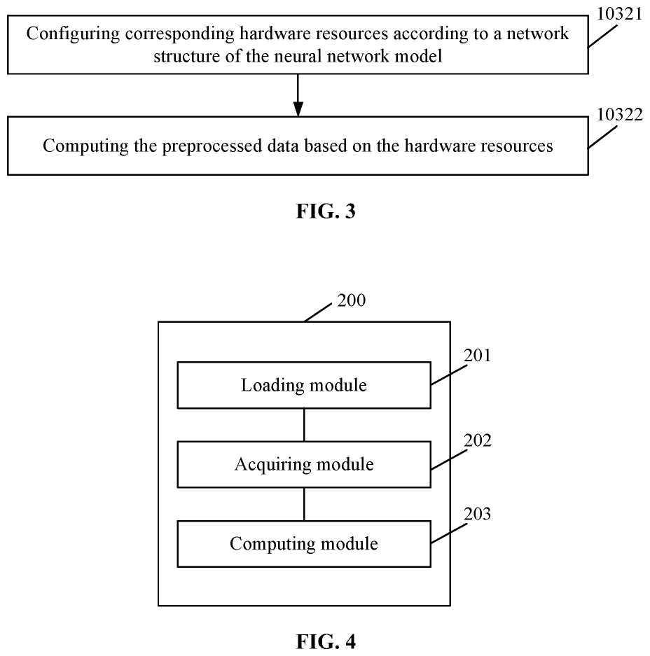

Further, as shown in FIG. 3, the above 1032 specifically includes the following operations: 10321 and 10322.

10321: configuring corresponding hardware resources according to network structures of the corresponding neural network models.

10322: computing the preprocessed data based on the corresponding hardware resources.

In this embodiment, different neural network models may be loaded according to different application scenes and different task types. For example, for a speech recognition application scene, pre-trained neural network models for speech processing, such as RNN, LSTM and the like, can be loaded; for an object detection scene, pre-trained neural network models for image processing, such as FAST-RCNN (including multiple specific sub-networks) and the like, can be loaded. Corresponding hardware resources can be configured according to the above loaded neural network models, that is, according to the network structures of the above neural network models and parameters of the above neural network models, hardware resources such as computation units, storage units, pipeline acceleration units and the like can be allocated. Based on the above configured hardware resources, corresponding operations, such as convolution operations, pooling operations and the like can be performed to the above preprocessed data.

Further, training performed to the above-mentioned pre-trained neural network models includes constructing a neural network, selecting a training data set and training the constructed neural network using the selected training data set, and verifying the trained neural network.

The constructing different neural networks according to task types or application scenes may include constructing network structure division, constructing number of layers, constructing connection manners, and the like; selecting corresponding data sets to train the constructed neural networks, where the data sets may be selected from open labeled data sets on the network, such as the MNIST data set for image recognition, the VoxCeleb data set for speech recognition, and the like; and, performing cross-verification to the trained neural networks through verification data sets, to obtain the above-mentioned pre-trained neural network models.

In a second aspect, please refer to FIG. 4. FIG. 4 is a schematic structural diagram of a neural network scheduling apparatus according to an embodiment of the present disclosure. As shown in FIG. 4, the neural network scheduling apparatus 200 includes: a loading module 201, an acquiring module 202, and a computing module 203.

The loading module 201 is configured to load at least one pre-trained neural network model to a model storage area in a memory, and acquire a base address of the at least one neural network model, where the memory further includes a common data storage area.

The acquiring module 202 is configured to acquire base addresses of corresponding neural network models according to a task type, and read data in the common data storage area.

The computing module 203 is configured to invoke, on the basis of the base addresses of the corresponding neural network models, the corresponding neural network models to compute the data read in the common data storage area to obtain a computation result and to output the computation result.

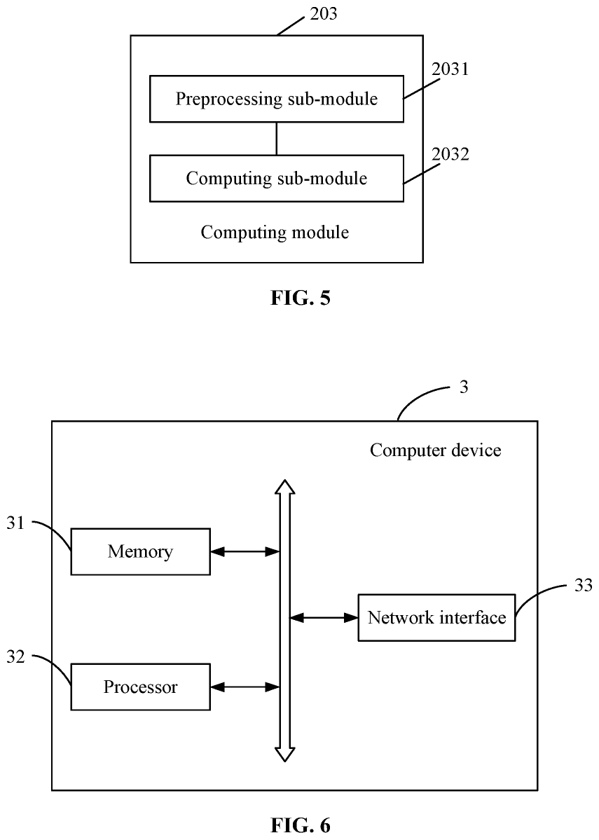

Further, as shown in FIG. 5, the above computing module 203 includes: a preprocessing sub-module 2031 and a computing sub-module 2032.

The preprocessing sub-module 2031 is configured to preprocess the data.

The computing sub-module 2032 is configured to input the preprocessed data into the invoked neural network for computation.

In a third aspect, a computer device is provided according to embodiments of the present disclosure, which includes: a memory, a processor, and a computer program stored in the memory and executable by the processor, and when the processor executes the computer program, the processor implements the neural network scheduling method according to any of the embodiments of the present disclosure.

In a fourth aspect, a computer-readable storage medium is provided according to embodiments of the present disclosure, a computer program is stored in the computer-readable storage medium, and when the computer program is executed by a processor, the neural network scheduling method according to any of the embodiments of the present disclosure is implemented. That is, in the embodiments of the present disclosure, when the computer program on the computer-readable storage medium is executed by a processor, the above-mentioned neural network scheduling method is implemented, which can reduce additional device costs and improve the utilization rate of hardware resources.

As an example, the computer program of the computer-readable storage medium includes computer program code, which may be in a form of source code, in a form of object code, in a form of executable file, in some intermediate forms, or the like. The computer-readable medium may include any entity or apparatus which can records the computer program code, such as a recording medium, a U disk, a removable hard disk, a magnetic disk, an optical disk, a computer memory, a read-only memory (ROM), a random access memory (RAM), an electric carrier signal, a telecommunication signal, a software distribution medium, and the like.

It is to be noted that, the operations of the above-described neural network scheduling method are implemented when the computer program of the computer-readable storage medium is executed by a processor, therefore, all embodiments of the above-described neural network scheduling method are applicable to the computer-readable storage medium, and same or similar beneficial effects can be achieved.

It can be understood by those of ordinary skill in the art that in the implementation of the above-described embodiments, a computer program may be used to instruct relevant hardware to implement all or part of processes of the method, and all or part of sub-systems of the system. The computer program may be stored in a computer readable storage medium. When the program is executed, the functions of the above-mentioned sub-systems embodiments may be realized. The aforementioned storage medium may be a non-volatile storage medium such as a magnetic disk, an optical disk, a read-only memory (ROM), or a random access memory (RAM) or the like.

It should be understood that although the various sub-systems in the schematic structural diagrams of the drawings are sequentially shown in an order indicated by arrows, these sub-systems are not necessarily executed in sequence in the order indicated by the arrows. Unless explicitly stated herein, the execution of these sub-systems is not strictly limited to the order and may be executed in other orders. Moreover, at least a part of the sub-systems in the schematic structural diagrams of the drawings may include multiple sub-operations or multiple stages during execution. These sub-operations or stages are not necessarily executed or performed at the same time, but may be executed at different times. These sub-operations or stages are not necessarily to be executed in a sequential order either, but these sub-operations or stages and other operations may be executed in turns or alternately, or these sub-operations or stages and at least a part of sub-operations or stages of other operations may be executed in turns or alternately.

Please continue to refer to FIG. 6. In order to address the above technical problem, a basic structural diagram of the above computer device is further provided according to an embodiment of the present disclosure, as shown in FIG. 6.

The computer device 3 includes a memory 31, a processor 33, and a network interface 33 which are in communication and connection with each other through a system bus. It should be pointed out that only the computer device 3 with the components 31 to 33 is shown in the FIG. 6, but it should be understood that it is not required to implement all of the shown components, and more or less components may be implemented instead. The person skilled in the art would understand that the computer device herein is a device that can automatically perform numerical computation and/or information processing according to pre-set or pre-stored instructions, and include a hardware such as a microprocessor, an application specific integrated circuit (ASIC), a field-programmable gate array (FPGA), a digital signal processor (DSP), an embedded device, etc., which is not limited thereto.

The computer device may be a desktop computer, a laptop, a palmtop computer, a cloud server and other computing devices. The computer device may perform human-machine interaction with a user through a keyboard, a mouse, a remote control, a touch pad, a voice control device or the like.

The memory 31 includes at least one type of readable storage medium, and the readable storage medium includes a flash memory, a hard disk, a multimedia card, a card-type memory (for example, SD or DX memory, etc.), a random access memory (RAM), a static random access memory (SRAM), a read only memory (ROM), an electrically erasable programmable read only memory (EEPROM), a programmable read only memory (PROM), a magnetic memory, a magnetic disk, an optical disk, etc. In some embodiments, the memory 31 may be an internal storage unit of the computer device 3, for example, a hard disk or memory of the computer device 3. In other embodiments, the memory 31 may also be an external storage device of the computer device 3, for example, a plug-in hard disk, a smart media card (SMC), a secure digital (SD) card, a flash memory card (Flash Card), etc. equipped for the computer device 3. Apparently, the memory 31 may also include both the internal storage unit of the computer device 3 and the external storage device of the computer device 3. In this embodiment, the memory 31 is generally configured to store an operation system and various application software installed on the computer device 3, for example, the program code of the above-described neural network scheduling method. In addition, the memory 31 can also be configured to temporarily store various types of output data or to-be-output data.

In some embodiments, the processor 33 may be a central processing unit (CPU), a controller, a microcontroller, a microprocessor, or other data processing chips. This processor 33 is typically configured to control the overall operation of the computer device 3. In this embodiment, the processor 33 is configured to run the program code stored in the memory 31 or to process data, for example, to run the program code for the neural network scheduling method.

The network interface 33 may include a wireless network interface or a wired network interface, and the network interface 33 is generally configured to establish a communication connection between the computer device 3 and other electronic devices, and to transmit data and the like.

Another embodiment is further provided according to the present disclosure, which is to provide a computer-readable storage medium, where the computer-readable storage medium stores a program for the neural network scheduling method, and the program for the neural network scheduling method can be executed by at least one processor, to cause the at least one processor to run the program for the above-described neural network scheduling method to realize corresponding functions.

From the description of the above embodiments, the person skilled in the art can clearly understand that the method of the above embodiments can be implemented by means of software plus a necessary general-purpose hardware platform, and apparently can also be implemented by means of hardware alone, but in most cases the former one is a better choice. Based on this understanding, the essence or a part, that contributes to the conventional technology, of the technical solutions of the present disclosure can be embodied in a form of a software product, and the computer software product is stored in a storage medium (such as an ROM/RAM, a magnetic disk, an optical disc, or the like), and includes several instructions to cause a terminal device (which may be a mobile phone, a computer, a server, an air conditioner, or a network device, etc.) to execute the methods described in the various embodiments of the present disclosure.

Apparently, the above-described embodiments are only a part of the embodiments of the present disclosure, rather than all of the embodiments. The drawings show preferred embodiments of the present disclosure, rather than limiting the scope of the patent of the present disclosure. This application may be embodied in many different forms, rather, the purpose of providing these embodiments is to enable the disclosure of this application to be understood more thoroughly and completely. Although the present disclosure has been described in detail with reference to the foregoing embodiments, the person skilled in the art can still modify the technical solutions described in the foregoing embodiments, or perform equivalent replacements for some of the technical features. Any equivalent structure made by using the contents of the description and drawings of the present disclosure, which is directly or indirectly used in other related technical fields, falls within the protection scope of the present disclosure.

1. A neural network scheduling method, comprising:
loading at least one pre-trained neural network model to a model storage area in a memory, and acquiring a base address of the at least one neural network model, wherein the memory further comprises a common data storage area;
acquiring base addresses of corresponding neural network models according to a task type, and reading data in the common data storage area; and
invoking, on the basis of the base addresses of the corresponding neural network models, the corresponding neural network models to compute the data read in the common data storage area to obtain a computation result, and outputting the computation result.

2. The method according to claim 1, wherein the model storage area is configured to store a network structure of the at least one neural network model and parameters of the at least one neural network model.

3. The method according to claim 1, wherein the base address is an initial storage address of a neural network model in the memory.

4. The method according to claim 3, wherein the step of invoking, on the basis of the base addresses of the corresponding neural network models, the corresponding neural network models to compute the data read in the common data storage area specifically comprises:
preprocessing the data; and
inputting the preprocessed data into the invoked neural network for computation.

5. The method according to claim 4, wherein the step of inputting the preprocessed data into the invoked neural network for computation comprises:
configuring corresponding hardware resources according to network structures of the corresponding neural network models; and
computing the preprocessed data based on the corresponding hardware resources.

6. The method according to claim 1, wherein training performed to the at least one pre-trained neural network model comprises: constructing a neural network, selecting a training data set and training the constructed neural network using the selected training data set, and verifying the trained neural network.

7. (canceled)

8. (canceled)

9. A computer device, comprising a memory and a processor, wherein a computer program is stored in the memory, and the processor, when executing the computer program, implements:
loading at least one pre-trained neural network model to a model storage area in a memory, and acquiring a base address of the at least one neural network model, wherein the memory further comprises a common data storage area;
acquiring base addresses of corresponding neural network models according to a task type, and reading data in the common data storage area; and
invoking, on the basis of the base addresses of the corresponding neural network models, the corresponding neural network models to compute the data read in the common data storage area to obtain a computation result, and outputting the computation result.

10. A non-transitory computer-readable storage medium, wherein a computer program is stored in the non-transitory computer-readable storage medium, and the computer program, when being executed by a processor, implements:
loading at least one pre-trained neural network model to a model storage area in a memory, and acquiring a base address of the at least one neural network model, wherein the memory further comprises a common data storage area;
acquiring base addresses of corresponding neural network models according to a task type, and reading data in the common data storage area; and
invoking, on the basis of the base addresses of the corresponding neural network models, the corresponding neural network models to compute the data read in the common data storage area to obtain a computation result, and outputting the computation result.

11. The computer device according to claim 9, wherein the model storage area is configured to store a network structure of the at least one neural network model and parameters of the at least one neural network model.

12. The computer device according to claim 9, wherein the base address is an initial storage address of a neural network model in the memory.

13. The computer device according to claim 12, wherein the processor, when executing the computer program, implements:
preprocessing the data; and
inputting the preprocessed data into the invoked neural network for computation.

14. The computer device according to claim 13, wherein the processor, when executing the computer program, implements:
configuring corresponding hardware resources according to network structures of the corresponding neural network models; and
computing the preprocessed data based on the corresponding hardware resources.

15. The computer device according to claim 9, wherein training performed to the at least one pre-trained neural network model comprises: constructing a neural network, selecting a training data set and training the constructed neural network using the selected training data set, and verifying the trained neural network.

16. The storage medium according to claim 10, wherein the model storage area is configured to store a network structure of the at least one neural network model and parameters of the at least one neural network model.

17. The storage medium according to claim 10, wherein the base address is an initial storage address of a neural network model in the memory.

1. The storage medium according to claim 17, wherein the computer program, when being executed by a processor, implements:
preprocessing the data; and
inputting the preprocessed data into the invoked neural network for computation.

19. The storage medium according to claim 18, wherein the computer program, when being executed by a processor, implements:
configuring corresponding hardware resources according to network structures of the corresponding neural network models; and
computing the preprocessed data based on the corresponding hardware resources.

20. The storage medium according to claim 10, wherein training performed to the at least one pre-trained neural network model comprises: constructing a neural network, selecting a training data set and training the constructed neural network using the selected training data set, and verifying the trained neural network.
